(19) United States
(12) Patent Application Publication
(10) Pub. No.: US 2016/0364511 A1
(43) Pub. Date: Dec. 15, 2016

(54) Constructing Additive Trees Monotonic in Selected Sets of Variables

(71) Applicant: Skytree, Inc., San Jose, CA (US)

(72) Inventor: Sergey Kirshner, Palo Alto, CA (US)

(21) Appl. No.: 15/178,549

(22) Filed: Jun. 9, 2016

Related U.S. Application Data
(60) Provisional application No. 62/173,013, filed on Jun. 9, 2015.

(51) Int. Cl. G06F 17/50; G06N 99/00; G06F 17/11

(52) U.S. Cl. CPC G06F 17/5009; G06F 17/11; G06N 99/005; G06F 2217/16

(57) ABSTRACT

A system and method for generating monotonicity constraints and integrating the monotonicity constraints with an additive tree model includes receiving the additive tree model trained on a dataset, receiving a selection of a set of subsets of variables on which to impose monotonicity of partial dependence functions, generating a set of monotonicity constraints for the partial dependence functions in the selected set of subsets of variables based on the dataset and a set of parameters of the additive tree model, receiving a selection of an objective function, and optimizing the objective function subject to the set of monotonicity constraints.

### CROSS REFERENCE TO RELATED APPLICATIONS

The present application claims priority, under 35 U.S.C. §119, of U.S. Provisional Patent Application No. 62/173,013, filed Jun. 9, 2015 and entitled “Constructing Additive Trees Monotonic in Selected Sets of Variables,” which is incorporated by reference in its entirety.

### BACKGROUND

The present disclosure relates to imposing monotonic relationships between input features (i.e., covariates) and an output response (i.e. a label) as constraints on the prediction function. More particularly, the present disclosure relates to systems and methods for determining monotonicity of the partial dependence functions in the selected sets of variables and in the selected direction to constrain the prediction function. Still more particularly, the present disclosure relates to determining an additive tree model to transform its partial dependence functions monotonic in the selected sets of variables.

In some domains, prior knowledge may suggest a monotonic relationship between some of the input features and output responses. One problem in the existing implementations of machine learning models is that a model produced in a training environment rarely encodes such monotonic relationships. More often than not, the model generates a prediction that can be non-monotonic, inaccurate, and potentially non-intuitive, even though the prior knowledge suggests otherwise. Another problem is the predictions made by such a model cannot be effectively explained to (e.g. to consumers, regulators, etc.) based on the scores of the model. These are just some of the problems encountered when the prior knowledge and what the prior knowledge suggests is overlooked in the implementations of the machine learning models.

Thus, there is a need for a system and method that imposes such monotonic relationships as constraints in the construction of machine learning models.

### SUMMARY

The present disclosure overcomes the deficiencies of the prior art by providing a system and method for generating and integrating monotonicity constraints with an additive tree model.

In general, another innovative aspect of the present disclosure described in this disclosure may be embodied in a method for receiving the additive tree model trained on a dataset, receiving a selection of a set of subsets of variables on which to impose monotonicity of partial dependence functions, generating a set of monotonicity constraints for the partial dependence functions in the selected set of subsets of variables based on the dataset and a set of parameters of the additive tree model, receiving a selection of an objective function, and optimizing the objective function subject to the set of monotonicity constraints.

Other aspects include corresponding methods, systems, apparatus, and computer program products for these and other innovative aspects. These and other implementations may each optionally include one or more of the following features.

For instance, the operations further include receiving a first selection of a first subset of a first variable, the first subset of the first variable including a first range of the first variable and a first sign of monotonicity of the first variable for a first partial dependence function in the first variable and receiving a second selection of a second subset of the first variable, the second subset of the first variable including a second range of the first variable and a second sign of monotonicity of the second variable for a second partial dependence function in the first variable. For instance, the operations further include receiving a first selection of a first subset of a first variable and a second variable, the first subset of the first variable and the second variable including a first range of the first variable, a second range of the second variable, and a sign of monotonicity of the first variable and the second variable for a multivariate partial dependence function in the first variable and the second variable. For instance, the operations further include re-estimating the set of parameters, wherein the re-estimated set of parameters satisfy the set of monotonicity constraints. For instance, the operations further include generating a prediction using the additive tree model and the re-estimated set of parameters.

For instance, the features further include the first subset of the first variable and the second subset of the second variable being included in the set of subsets of variables. For instance, the features further include the first subset of the first variable and the second variable being included in the set of subsets of variables. For instance, the features further include the additive tree model being one from a group of gradient boosted trees, additive groves of regression trees and regularized greedy forest. For instance, the features further include the objective function being a penalized local likelihood. For instance, the features further include the set of monotonicity constraints being a function of the set of parameters of the additive tree model.

The present disclosure is particularly advantageous because the prediction function is constrained by the monotonicity of the partial dependence functions in the selected variables. The additive tree model integrated with such monotonicity constraints not only improves the explainability of the model scoring but also the predictive accuracy of the model by imposing prior knowledge to counter the noise of the data.

The features and advantages described herein are not all-inclusive and many additional features and advantages should be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example of a system for generating and integrating monotonicity constraints with an additive tree model in accordance with one implementation of the present disclosure.

FIG. 2 is a block diagram illustrating an example of a training server in accordance with one implementation of the present disclosure.

FIG. 3 is a graphical representation of example partial dependence plots of constrained variables for a housing dataset in accordance with one implementation of the present disclosure.

FIG. 4 is a graphical representation of example partial dependence plots of constrained variables for an income dataset in accordance with one implementation of the present disclosure.

FIG. 5 is a flowchart of an example method for generating monotonicity constraints in accordance with one implementation of the present disclosure.

FIG. 6 is a flowchart of another example method for generating monotonicity constraints in accordance with one implementation of the present disclosure.

### DETAILED DESCRIPTION

A system and method for generating and integrating monotonicity constraints with an additive tree model is described. In the following description, for purposes of explanation, numerous specific details are set forth in order to provide a thorough understanding of the disclosure. It should be apparent, however, that the disclosure may be practiced without these specific details. In other instances, structures and devices are shown in block diagram form in order to avoid obscuring the disclosure. For example, the present disclosure is described in one implementation below with reference to particular hardware and software implementations. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation. In particular the present disclosure is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems should appear from the description below. In addition, the present disclosure is described without reference to any particular programming language. It should be appreciated that a variety of programming languages may be used to implement the teachings of the disclosure as described herein.

### Example System(s)

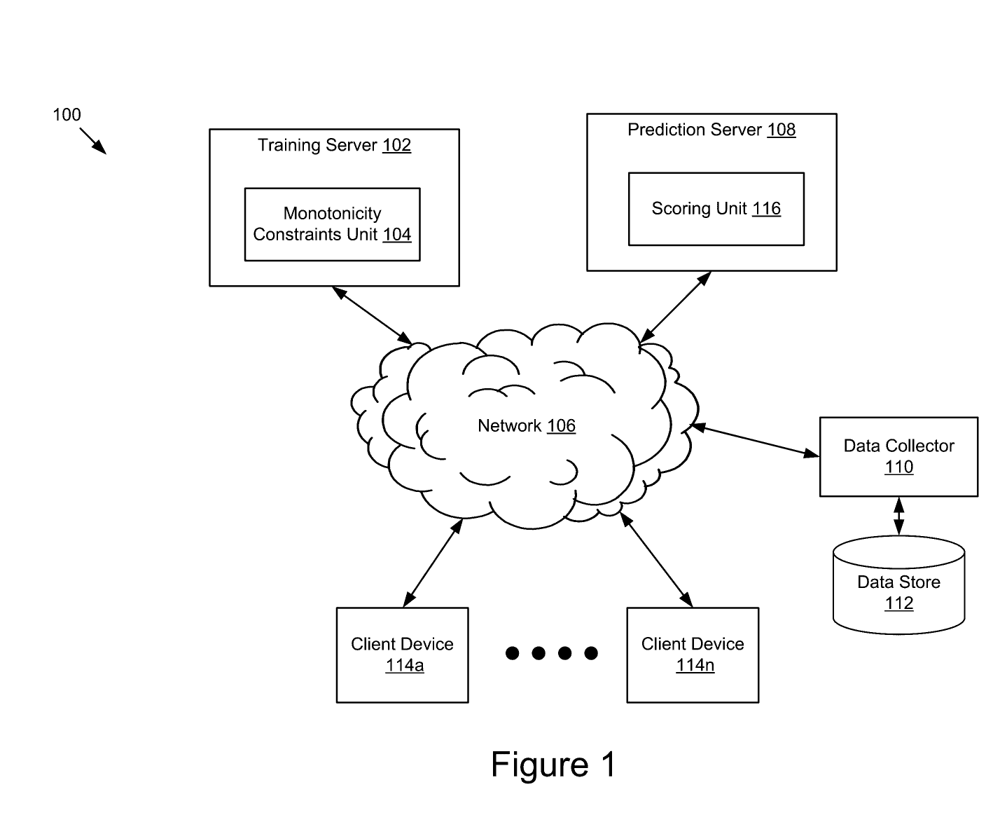

FIG. 1 is a block diagram illustrating an example of a system for generating and integrating monotonicity constraints with an additive tree model in accordance with one implementation of the present disclosure. Referring to FIG. 1, the illustrated system 100 comprises: a training server 102 including a monotonicity constraints unit 104, a prediction server 108 including a scoring unit 116, a plurality of client devices 114a . . . 114n, and a data collector 110 and associated data store 112. In FIG. 1 and the remaining figures, a letter after a reference number, e.g., “114a,” represents a reference to the element having that particular reference number. A reference number in the text without a following letter, e.g., “114,” represents a general reference to instances of the element bearing that reference number. In the depicted implementation, the training server 102, the prediction server 108, the plurality of client devices 114a . . . 114n, and the data collector 110 are communicatively coupled via the network 106.

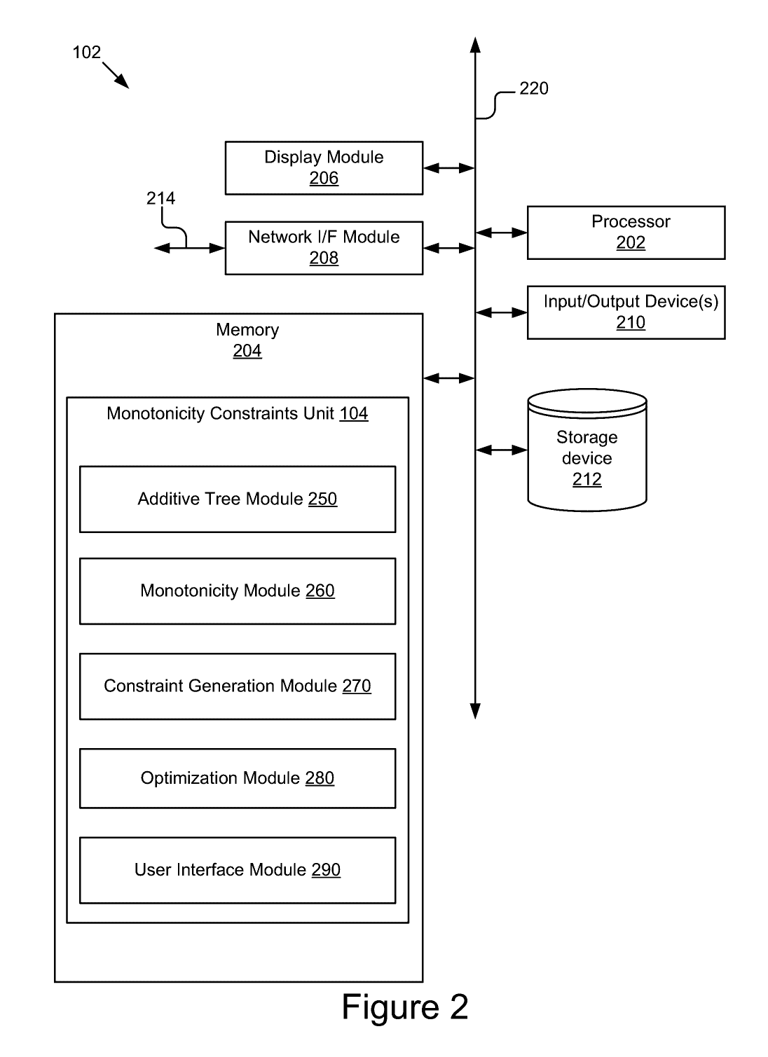

In some implementations, the system 100 includes a training server 102 coupled to the network 106 for communication with the other components of the system 100, such as the plurality of client devices 114a . . . 114n, the prediction server 108, and the data collector 110 and associated data store 112. In some implementations, the training server 102 may either be a hardware server, a software server, or a combination of software and hardware. In some implementations, the training server 102 is a computing device having data processing (e.g., at least one processor), storing (e.g., a pool of shared or unshared memory), and communication capabilities. For example, the training server 102 may include one or more hardware servers, server arrays, storage devices and/or systems, etc. In the example of FIG. 1, the component of the training server 102 may be configured to implement the monotonicity constraints unit 104 described in detail below with reference to FIG. 2. In some implementations, the training server 102 provides services to a data analysis customer by facilitating a generation of monotonicity constraints for a set of variables and integration of the monotonicity constraints with an additive tree model. In some implementations, the training server 102 provides the constrained additive tree model to the prediction server 108 for use in processing new data and generating predictions that are monotonic in the set of variables. Also, instead of or in addition, the training server 102 may implement its own API for the transmission of instructions, data, results, and other information between the training server 102 and an application installed or otherwise implemented on the client device 114. Although only a single training server 102 is shown in FIG. 1, it should be understood that there may be any number of training servers 102 or a server cluster, which may be load balanced.

In some implementations, the system 100 includes a prediction server 108 coupled to the network 106 for communication with other components of the system 100, such as the plurality of client devices 114a . . . 114n, the training server 102, and the data collector 110 and associated data store 112. In some implementations, the prediction server 108 may be either a hardware server, a software server, or a combination of software and hardware. The prediction server 108 may be a computing device having data processing, storing, and communication capabilities. For example, the prediction server 108 may include one or more hardware servers, server arrays, storage devices and/or systems, etc. In some implementations, the prediction server 108 may include one or more virtual servers, which operate in a host server environment and access the physical hardware of the host server including, for example, a processor, memory, storage, network interfaces, etc., via an abstraction layer (e.g., a virtual machine manager). In some implementations, the prediction server 108 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106 (e.g., the training server 102, the data collector 110, the client device 114, etc.).

In the example of FIG. 1, the components of the prediction server 108 may be configured to implement scoring unit 116. In some implementations, the scoring unit 116 receives a model from the training server 102, deploys the model to process data and provide predictions prescribed by the model. For purposes of this application, the terms “prediction” and “scoring” are used interchangeably to mean the same thing, namely, to turn predictions (in batch mode or online) using the model. In machine learning, a response variable, which may occasionally be referred to herein as a “response,” refers to a data feature containing the objective result of a prediction. A response may vary based on the context (e.g. based on the type of predictions to be made by the machine learning method). For example, responses may include, but are not limited to, class labels (classification), targets (general, but particularly relevant to regression), rankings (ranking/recommendation), ratings (recommendation), dependent values, predicted values, or objective values. Although only a single prediction server 108 is shown in FIG. 1, it should be understood that there may be a number of prediction servers 108 or a server cluster, which may be load balanced.

The data collector 110 is a server/service which collects data and/or analysis from other servers (not shown) coupled to the network 106. In some implementations, the data collector 110 may be a first or third-party server (that is, a server associated with a separate company or service provider), which mines data, crawls the Internet, and/or receives/retrieves data from other servers. For example, the data collector 110 may collect user data, item data, and/or user-item interaction data from other servers and then provide it and/or perform analysis on it as a service. In some implementations, the data collector 110 may be a data warehouse or belonging to a data repository owned by an organization. In some implementations, the data collector 110 may receive data, via the network 106, from one or more of the training server 102, a client device 114 and a prediction server 108. In some implementations, the data collector 110 may receive data from real-time or streaming data sources.

The data store 112 is coupled to the data collector 108 and comprises a non-volatile memory device or similar permanent storage device and media. The data collector 110 stores the data in the data store 112 and, in some implementations, provides access to the training server 102 to retrieve the data collected by the data store 112 (e.g. training data, response variables, rewards, tuning data, test data, user data, experiments and their results, learned parameter settings, system logs, etc.).

Although only a single data collector 110 and associated data store 112 is shown in FIG. 1, it should be understood that there may be any number of data collectors 110 and associated data stores 112. In some implementations, there may be a first data collector 110 and associated data store 112 accessed by the training server 102 and a second data collector 110 and associated data store 112 accessed by the prediction server 108. It should also be recognized that a single data collector 112 may be associated with multiple homogenous or heterogeneous data stores (not shown) in some implementations. For example, the data store 112 may include a relational database for structured data and a file system (e.g. HDFS, NFS, etc.) for unstructured or semi-structured data. It should also be recognized that the data store 112, in some implementations, may include one or more servers hosting storage devices (not shown).

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, wireless application protocol (WAP), electronic mail, etc.

The client devices 114a . . . 114n include one or more computing devices having data processing and communication capabilities. In some implementations, a client device 114 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The client device 114a may couple to and communicate with other client devices 114n and the other entities of the system 100 via the network 106 using a wireless and/or wired connection.

A plurality of client devices 114a . . . 114n are depicted in FIG. 1 to indicate that the training server 102 and the prediction server 108 may communicate and interact with a multiplicity of users on a multiplicity of client devices 114a . . . 114n. In some implementations, the plurality of client devices 114a . . . 114n may include a browser application through which a client device 114 interacts with the training server 102, an application installed enabling the client device 114 to couple and interact with the training server 102, may include a text terminal or terminal emulator application to interact with the training server 102, or may couple with the training server 102 in some other way. In the case of a standalone computer implementation of the system 100, the client device 114 and training server 102 are combined together and the standalone computer may, similar to the above, generate a user interface either using a browser application, an installed application, a terminal emulator application, or the like. In some implementations, the plurality of client devices 114a . . . 114n may support the use of Application Programming Interface (API) specific to one or more programming platforms to allow the multiplicity of users to develop program operations for analyzing, visualizing and generating reports on items including datasets, models, results, features, etc. and the interaction of the items themselves.

Examples of client devices 114 may include, but are not limited to, mobile phones, tablets, laptops, desktops, netbooks, server appliances, servers, virtual machines, TVs, set-top boxes, media streaming devices, portable media players, navigation devices, personal digital assistants, etc. While two client devices 114a and 114n are depicted in FIG. 1, the system 100 may include any number of client devices 114. In addition, the client devices 114a . . . 114n may be the same or different types of computing devices.

It should be understood that the present disclosure is intended to cover the many different implementations of the system 100 that include the network 106, the training server 102 having a monotonicity constraints unit 104, the prediction server 108, the data collector 110 and associated data store 112, and one or more client devices 114. In a first example, the training server 102 and the prediction server 108 may each be dedicated devices or machines coupled for communication with each other by the network 106. In a second example, any one or more of the servers 102 and 108 may each be dedicated devices or machines coupled for communication with each other by the network 106 or may be combined as one or more devices configured for communication with each other via the network 106. For example, the training server 102 and the prediction server 108 may be included in the same server. In a third example, any one or more of the servers 102 and 108 may be operable on a cluster of computing cores in the cloud and configured for communication with each other. In a fourth example, any one or more of one or more servers 102 and 108 may be virtual machines operating on computing resources distributed over the internet. In a fifth example, any one or more of the servers 102 and 108 may each be dedicated devices or machines that are firewalled or completely isolated from each other (i.e., the servers 102 and 108 may not be coupled for communication with each other by the network 106). For example, the training server 102 and the prediction server 108 may be included in different servers that are firewalled or completely isolated from each other.

While the training server 102 and the prediction server 108 are shown as separate devices in FIG. 1, it should be understood that, in some implementations, the training server 102 and the prediction server 108 may be integrated into the same device or machine. Particularly, where the training server 102 and the prediction server 108 are performing online learning, a unified configuration is preferred. Moreover, it should be understood that some or all of the elements of the system 100 may be distributed and operate on a cluster or in the cloud using the same or different processors or cores, or multiple cores allocated for use on a dynamic as-needed basis.

### Example Training Server 102

Referring now to FIG. 2, an example of a training server 102 is described in more detail according to one implementation. The illustrated training server 102 comprises a processor 202, a memory 204, a display module 206, a network I/F module 208, an input/output device 210 and a storage device 212 coupled for communication with each other via a bus 220. The training server 102 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the training server 102 may include various operating systems, sensors, additional processors, and other physical configurations.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. The processor 202 may also include an operating system executable by the processor 202 such as but not limited to WINDOWS®, Mac OS®, or UNIX® based operating systems. In some implementations, the processor(s) 202 may be coupled to the memory 204 via the bus 220 to access data and instructions therefrom and store data therein. The bus 220 may couple the processor 202 to the other components of the training server 102 including, for example, the display module 206, the network I/F module 208, the input/output device(s) 210, and the storage device 212.

The memory 204 may store and provide access to data to the other components of the training server 102. The memory 204 may be included in a single computing device or a plurality of computing devices. In some implementations, the memory 204 may store instructions and/or data that may be executed by the processor 202. For example, as depicted in FIG. 2, the memory 204 may store the monotonicity constraints unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of training server 102.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the training server 102. It should be understood that the memory 204 may be a single device or may include multiple types of devices and configurations.

The display module 206 may include software and routines for sending processed data, analytics, or results for display to a client device 114, for example, to allow an administrator to interact with the training server 102. In some implementations, the display module 206 may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. In some implementations, the network I/F module 208 also provides other conventional connections to the network 106 for distribution of files using standard network protocols such as transmission control protocol and the Internet protocol (TCP/IP), hypertext transfer protocol (HTTP), hypertext transfer protocol secure (HTTPS) and simple mail transfer protocol (SMTP) as should be understood to those skilled in the art. In some implementations, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, the network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MMS), hypertext transfer protocol (HTTP), direct data connection, wireless application protocol (WAP), email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the training server 102 and may be coupled to the system either directly or through intervening I/O controllers. An input device may be any device or mechanism of providing or modifying instructions in the training server 102. For example, the input device may include one or more of a keyboard, a mouse, a scanner, a joystick, a touchscreen, a webcam, a touchpad, a touchscreen, a stylus, a barcode reader, an eye gaze tracker, a sip-and-puff device, a voice-to-text interface, etc. An output device may be any device or mechanism of outputting information from the training server 102. For example, the output device may include a display device, which may include light emitting diodes (LEDs). The display device represents any device equipped to display electronic images and data as described herein. The display device may be, for example, a cathode ray tube (CRT), liquid crystal display (LCD), projector, or any other similarly equipped display device, screen, or monitor. In one implementation, the display device is equipped with a touch screen in which a touch sensitive, transparent panel is aligned with the screen of the display device. The output device indicates the status of the training server 102 such as: 1) whether it has power and is operational; 2) whether it has network connectivity; 3) whether it is processing transactions. Those skilled in the art should recognize that there may be a variety of additional status indicators beyond those listed above that may be part of the output device. The output device may include speakers in some implementations.

The storage device 212 is an information source for storing and providing access to data, such as a plurality of datasets, transformations, model(s), constraints, etc. The data stored by the storage device 212 may be organized and queried using various criteria including any type of data stored by it. The storage device 212 may include data tables, databases, or other organized collections of data. The storage device 212 may be included in the training server 102 or in another computing system and/or storage system distinct from but coupled to or accessible by the training server 102. The storage device 212 may include one or more non-transitory computer-readable mediums for storing data. In some implementations, the storage device 212 may be incorporated with the memory 204 or may be distinct therefrom. In some implementations, the storage device 212 may store data associated with a relational database management system (RDBMS) operable on the training server 102. For example, the RDBMS could include a structured query language (SQL) RDBMS, a NoSQL RDMBS, various combinations thereof, etc. In some instances, the RDBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3.

The bus 220 represents a shared bus for communicating information and data throughout the training server 102. The bus 220 may represent one or more buses including an industry standard architecture (ISA) bus, a peripheral component interconnect (PCI) bus, a universal serial bus (USB), or some other bus known in the art to provide similar functionality which is transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the training server 102 (operating systems, device drivers, etc.), and any of the components of the monotonicity constraints unit 104 may cooperate and communicate via a communication mechanism included in or implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the monotonicity constraints unit 104 may include and may signal the following to perform their functions: an additive tree module 250 that receives an additive tree model and a dataset from a data source (e.g., from the data collector 110 and associated data store 112, the client device 114, the storage device 212, etc.), processes the additive tree model for extracting metadata (e.g., tree leaf parameters θ, splits S, etc.) and stores the metadata in the storage device 212, a monotonicity module 260 that receives a set of subsets of variables and imposes monotonicity on the partial dependence functions in the selected subsets of variables, a constraint generation module 270 that generates a set of monotonicity constraints, an optimization module 280 that receives an objective function and optimizes the objective function subject to the set of monotonicity constraints, and a user interface module 290 that cooperates and coordinates with other components of the monotonicity constraints unit 104 to generate a user interface that may present the user experiments, features, models, plots, data sets, or projects. These components 250, 260, 270, 280, 290, and/or components thereof, may be communicatively coupled by the bus 220 and/or the processor 202 to one another and/or the other components 206, 208, 210, and 212 of the training server 102. In some implementations, the components 250, 260, 270, 280 and/or 290 may include computer logic (e.g., software logic, hardware logic, etc.) executable by the processor 202 to provide their acts and/or functionality. In any of the foregoing implementations, these components 250, 260, 270, 280 and/or 290 may be adapted for cooperation and communication with the processor 202 and the other components of the training server 102.

It should be recognized that the monotonicity constraints unit 104 and disclosure herein applies to and may work with Big Data, which may have billions or trillions of elements (rows×columns) or even more, and that the user interface elements are adapted to scale to deal with such large datasets, resulting large models and results and provide visualization, while maintaining intuitiveness and responsiveness to interactions.

The additive tree module 250 includes computer logic executable by the processor 202 to receive a dataset and determine an additive tree model based on the dataset. The additive tree module 250 determines the additive tree model with the hyperparameter set (e.g., number of trees, maximum number of binary splits per tree, learning rate) of the additive tree model tuned to increase a cross-validated or a hold-out score. For example, the additive tree model can be gradient boosted trees, additive groves of regression trees and regularized greedy forest. In some implementations, the additive tree module 250 receives an existing tree model including a set of parameters and the number of splits together with the dataset on which the additive tree model was trained. Such implementations may beneficially allow a user to correct or improve existing additive tree models by imposing monotonicity.

It should be noted that while linear models would allow for variable constraints, there are advantages to using an additive tree model to make the learned function. The additive tree model can incorporate categorical and real-valued variables together. For example, a FICO score is real-valued variable and a zip code is a categorical variable. The additive tree model provides a way to combine interactions between these different types of variables. The additive tree model also allows creation of new features. However, previous methods fail to provide a way to constrain an additive tree model such that it is monotonic with a set of selected input features or variables. This failure did not allow data users to leverage domain knowledge about a set of features or variables and impose monotonicity on the learned function in the set of features or variables.

In function approximation using additive trees, each tree T: X→ [symbol] is a regression function which recursively partitions X into multi-dimensional rectangular subregions and assigns a constant function value for each of these sub regions. Considering binary partitions at each step; the corresponding sub region construction is naturally represented as a binary tree. The tree starts out with a single node (the root) corresponding to the region [symbol] ₀=X. At each step of the partitioning, one leaf node is split into two by partitioning the corresponding rectangular region into two rectangular regions by cutting it along one of the variables, e.g., Xᵢ≦2 or Xᵢ>2 for a real-valued variable Xᵢ, or Xᵢ∈(a) or Xᵢ ∉{a} for a categorical variable Xᵢ. Each leaf node l corresponds to a contiguous region [symbol] ₗ which is assigned the same function value θₗ. A tree is then parametrized by the set of splits S and the set of nodes θ=(θ₁: l∈leaves(T)). In essence, each regression tree defined as a multi-dimensional step function is stated below:

$$T ( x \vert S , θ ) = {\sum }_{l ∈ leaves ( T )} {θ}_{l} ( x ∈ {ℛ}_{l} )$$

where the flat regions [symbol] ₗ are structured in a hierarchy and correspond to the leaf nodes in the hierarchy. The function ƒ is then approximated using a sum of K trees,

$$h ( x ; S , θ ) = {\sum }_{k = 1}^{K} {T}_{k} ( x ; {S}_{k} , {θ}_{k} ) , P ( y \text{\textbar} x ) = g ( h ( x ; S , θ ) , y ) .$$

In an additive tree model, there is an underlying prediction function that is learned and mapped to a probability or a predicted value. As described in the above equation, a function g maps the sum of tree contributions to a probability value, e.g., g(h,y)=[1+exp(−yh)]⁻¹ for classification function with Y=y∈{−1,1}, and

$$g ( h , y ) = \frac{1}{\sqrt{2 π}} exp [ - \frac{1}{2} {( y - h )}^{2} ]$$

or regression function with Y=y∈ [symbol] . A classification function may identify one or more classifications to which new input data belongs. For example, in the auditing of insurance claims, the classification function determines each claim as having either a label of legitimate or illegitimate. The classification function determines the legitimacy of claims for exclusions such as fraud, jurisdiction, regulation or contract. On the other hand, a regression function may determine a value or value range. For example, again in insurance claims processing, the regression function determines a true amount that should have been paid, a range that should have been used, or some proxy or derivative thereof. In some implementations, the additive tree module 250 sends the additive tree model to the prediction server 108 for scoring predictions.

The monotonicity module 260 includes computer logic executable by the processor 202 to receive a selection of a set of variables to impose a monotonicity on partial dependence functions in the selected set of variables. Sometimes, prior domain knowledge may suggest an input feature or covariate having a monotonic relationship with a response or label. For example, in the estimation of an applicant's credit default probability, it is intuitive to a banker that a lower credit score (FICO score) can suggest a higher probability of default by the applicant. The default probability can therefore be monotonic in the credit score. In another example, in the medical domain, the diagnosis (malignancy) of breast cancer by a doctor is monotonic in the size of certain epithelial cells. In another example, in the domain of ecology, scientists may expect that higher water visibility corresponds to higher soft coral richness and is, therefore, monotonic. In yet another example, in real estate pricing, a realtor may expect the price of a house to be monotonic in the total living area and the number of bedrooms.

A function h: X→Y (where X⊂ [symbol] , Y⊂R) is monotonic if ∀x, x′∈X: x<x′ [symbol] h(x)≦h(x′) (non-decreasing) or ∀x, x′∈X: x<x′ [symbol] h(x)≧h(x′) (non-increasing). If the inequality is strict, then the function ƒ is strictly monotonic. Monotonicity is extendable to the multivariate case where a multi-variant function h: X→Y (where X⊂ [symbol] ^{d}, Y⊂ [symbol] ) is monotonic if it is either non-decreasing,

∀(x₁, . . . ,x_{d}),(x′₁, . . . ,x′_{d})∈ [symbol] ^{d},(∀j=1, . . . ,d,xⱼ≦x′ⱼ) [symbol] h(x₁, . . . ,x_{d})≦h(x′₁, . . . ,x′_{d})

or non-increasing,

(x₁, . . . ,x_{d}),(x′₁, . . . ,x′_{d})∈ [symbol] ^{d},(∀j=1, . . . ,d,xⱼ≦x′ⱼ) [symbol] h(x₁, . . . ,x_{d})≧h(x′₁. . . ,x′_{d}).

The monotonicity definition above establishes the relationship involving all of the variables. The monotonicity on all variables may be impractical due to the demands it would put on resources (e.g. processor 202 cycles, bandwidth, etc.) or unwanted (e.g. because the user does not have domain knowledge that a variable should be monotonic, or a user considers a variable or the monotonicity of a variable less important). However, relationships that a domain user or expert wants to encode usually involve few (e.g., just one or several) of the variables, which may be many. In such cases, the monotonicity module 260 evaluates the monotonicity of the partial dependence functions where the compliment variables which are not part of the monotonic relationship are marginalized. The monotonicity module 260 defines the monotonicity on variables in terms of the partial dependence functions. If X_{V} is a set of selected features, and X_{V̅} is the set of the remaining features so that X=(X_{V}, X_{V̅}), then the monotonicity module 260 determines partial dependence function of h on X_{V} based on the equation as described below:

h_{V}(X_{V})=E_{X}_{_{V̅}}[h(X_{V},X_{V̅})].

From a finite sample (X₁, . . . , Xₙ), the monotonicity module 260 estimates h_{V}(x_{V}) based on the equation as described below:

$${\hat{h}}_{V} ( {x}_{V} ) = \frac{1}{{\sum }_{i = 1}^{N} {w}_{i}} {\sum }_{i = 1}^{N} {w}_{i} h ( {x}_{V} , {x}_{i \overline{V}} ) ,$$

where x_{iV̅} are the values of X_{V̅} occurring in the training set and w is the non-negative weight of training samples.

Consider the problem of classification or regression, with the task of learning ƒ:X→Y from a set of observations D=((xᵢ,yᵢ))_{i=1, . . . , N} where xₙ are drawn independent and identically distributed (i.i.d.) according to an unknown distribution over X and yᵢ are drawn (also i.i.d conditioned on xᵢ) according to an unknown distribution over Y for i=1, . . . , N. For binary classification, typically, Y={−1,1}, while for regression, Y= [symbol] or Y= [symbol] ₊. This disclosure considers the case of multi-dimensional X,

$$x = ( {x}_{1} , ⋯ , {x}_{d} ) ∈ X = {⊗}_{j = 1}^{d} {X}_{j}$$

where each variable could be either real-valued or categorical.

The observations can be assumed to be noisy with the known noise model family F where ƒ(x)=E_{Y˜F}[Y|X=x] is the location parameter for Y|X=x. For the case of regression, for example, F can be a univariate normal while for binary classification, F can be Bernoulli. Since E [Y|X] could potentially have limited range, the monotonicity module 260 models h(x)=g(E[Y|X=x]) instead where a g is a strictly monotonic link function with range [symbol] ; thus ƒ=g⁻¹∘h. Gaussian noise family is usually paired up with the identity link function, and binomial is commonly linked with the log it function,

$$g ( p ) = ln \frac{p}{1 - p} .$$

Since g is strictly increasing, h=g∘ƒ has the same monotonicity properties as ƒ.

The monotonicity module 260 receives a specification of a set of subsets of monotonic variables on which to impose monotonicity of the corresponding partial dependence functions, which was referred to as h_{V} for a subset of variables X_{V} above. In some implementations, the monotonicity module 260 imposes univariate monotonicity, (i.e., imposing monotonicity variable by variable). In other implementations, the monotonicity module 260 imposes multivariate monotonicity (i.e., imposing monotonicity on multiple variables at once).

In some implementations, the monotonicity module 260 receives a range of the monotonicity for each variable in each subset of monotonic variables, and a sign of monotonicity. In some implementations the range is received from a user (e.g. based on input in a graphical user interface presented to the user). In some implementations, the range is determined by the monotonicity module 260. For example, the range may be determined based on the data type (e.g. from −3.4E38 to 3.4E38 for a variable associated with a float data type), based on the range of values in the dataset (e.g. from the minimum value for a variable to a maximum value of a variable in the dataset), etc. depending on the implementation. In some implementations, a default range is determined by the monotonicity module 260 and replaced by a range received (e.g. responsive to user input in a GUI presented by the monotonicity constraint unit 104.

In some implementations, the monotonicity module 260 receives a request to impose piecewise monotonicity on partial dependence functions in subsets of variables with different ranges of monotonicity. For example, the monotonicity module 260 receives a set of subsets of variables, {({(A, [−10,10])}, ‘+’), ({(A, (10, ∞)}, ‘−’), ({(B, [−10, 5])}, ‘−’), ({(A, [−3, 7]), (C, [−1, 1])}, ‘+’)}, as input for specifying monotonicity involving three different variables A, B, and C on the partial dependence function h_{{A}}, h_{{B}}, h_{{A,C}}. The monotonicity module 260 identifies that that the partial dependence function h_{{A}} on univariate A in the subset ({(A, [−10,10])}, ‘+’) would be non-decreasing in the range [−10, 10], and in the subset ({(A, (10, ∞)}, ‘−’) would be non-increasing in the range (10, ∞). The monotonicity module 260 identifies that the partial dependence function h_{{B}} on univariate B in the subset ({(B, [−10, 5])}, ‘−’) would be non-increasing in the range [−10, 5]. The monotonicity module 260 identifies that the partial dependence function h_{{A,C}} on multivariate (A, C) in the subset ({(A, [−3, 7]), (C, [−1, 1])}, ‘+’) is non-decreasing on [−3, 7]×[−1, 1]. In another example, the monotonicity module 260 receives a set of subsets of variables, {({(AveRooms, [0,3])}, ‘+’), ({(AveBath, (0, 2)}, ‘+’), ({(LotSize, [0, 800])}, ‘+’), ({(AveRooms, [0, 3]), (AveBath, [0, 2])}, ‘+’)}, as input for specifying monotonicity involving variables “AveRooms,” “AveBath,” and “LotSize” in the housing price partial dependence functions. The monotonicity module 260 identifies that the partial dependence function on univariate “AveRooms” in the subset ({(AveRooms, [0,3])}, ‘+’) would be non-decreasing in the [0, 3]. The monotonicity module 260 identifies that the partial dependence function on univariate “AveBath” in the subset ({(AveBath, (0, 2)}, ‘+’) would be non-decreasing in the range [0, 2]. The monotonicity module 260 identifies that the partial dependence function on univariate “LotSize” in the subset ({(LotSize, [0, 800])}, ‘+’) would be non-decreasing in the range [0, 800]. The monotonicity module 260 identifies that the partial dependence function on multivariate (AveRooms, AveBath) in the subset ({(AveRooms, [0, 3]), (AveBath, [0, 2])}, ‘+’) is non-decreasing on [0, 3]×[0, 2]. Depending on the implementation, when imposing piecewise monotonicity on the same variable (e.g. “LotSize”), the ranges, which may be specified in different subsets, may not overlap or, if the ranges overlap, the sign (e.g. ‘−’ for non-increasing) must be identical for both ranges. In one implementation, if this is not the case, e.g., two at least partially overlapping ranges with different signs are selected for a single variable, an error is thrown and presented to the user so the user may modify the sign or ranges to be compliant.

The constraint generation module 270 includes computer logic executable by the processor 202 to generate a set of monotonicity constraints which enforces the partial dependence function monotonically increasing or monotonically decreasing in the selected set of variables over the associated range(s). In some implementations, the constraint generation module 270 receives the monotonic variables from the monotonicity module 260. The constraint generation module 270 receives the dataset and the additive tree model including the set of parameters from the additive tree module 250. The constraint generation module 270 generates the set of monotonicity constraints based on the dataset, the additive tree model and the monotonic variables. In some implementations, the monotonicity constraints are linear inequalities corresponding to the set of variables for which monotonicity of the partial dependence functions is being imposed. In some implementations, the constraint generation module 270 represents the set of monotonicity constraints as functions of the set of parameters of the additive tree model.

For example, the constraint generation module 270 receives the already constructed trees T₁, . . . , T_{K}. Each tree T_{K} is specified by split hyperplanes S_{K} for non-leaf nodes and function values θₖ at the leaves. Each non-leaf node n is associated with a split (uₖₙ, Vₖₙ) where the region Rₖₙ associated with this node is positioned according to Xᵤ_{ₖₙ}≦vₖₙ for its left child and Xᵤ_{ₖₙ}>vₖₙ for its right child. Each leaf node n has an associated function value θₖₙ so that Tₖ(x)=θₖₙ if x∈Rₖₙ.

Each constraint is a hyperplane. In some implementations, the constraint generation module 270 generates a set of constraints for a univariate partial dependence monotonicity. For example, the constraint generation module identifies a single tree and determines monotonicity constraints for a single variable Xᵥ. The constraint generation module 270 identifies the distinct split of values v₁, . . . , vₛ on variable Xᵥ in sorted order, ∞=v₀<v₁<v₂< . . . <vₛ<vₛ₊₁=∞. The constraint generation module 270 determines the partial dependence function in one variable Xᵥ based on the equation described below:

$${\hat{h}}_{\{ v \}} ( {x}_{v} ) = \frac{1}{{\sum }_{i = 1}^{N} {w}_{i}} {w}_{i} h ( {x}_{v} , {x}_{i \{ \overline{v \}}} )$$

The partial dependence function in one variable Xᵥ is a step function with at most number s+1 of distinct values, one for each of xᵥ∈(vₜ₋₁, vₜ], t=1, . . . , s+1. The constraint generation module 270 identifies each (vₜ₋₁, vₜ] as a value bin for Xᵥ. The constraint generation module 270 determines the constraint as ηₜ=ĥ_{{v}}(xᵥ) for xᵥ∈(vₜ₋₁, vₜ]. The constraint generation module 270 imposes s constraints for Xᵥ as described below:

$${𝒞}_{v} = \{ \begin{matrix}\{ {η}_{t} \leq {η}_{t + 1} : t = 1 , ⋯ , s \} & if non \text{-} decreasing ; \\ \{ {η}_{t} \geq {η}_{t + 1} \text{:} t = 1 , ⋯ , s \} & if non \text{-} increasing .\end{matrix}$$

For a regression tree involving only univariate splits s, the constraint generation module 270 represents each of the ηₜs as a function, for example, a linear combination of the tree leaf parameters θ. In some implementations, the constraint generation module 270 uses the algorithm described in Table 1 for determining the coefficient aₜ so that ηₜ=aₜ^{T}e.

TABLE 1
Algorithm 2 Compute vectors of linear coefficient for each of
s + 1 value bins for variable Xᵥ in a regression tree with root root.

| | Assumptions: | |
|---|---|---|
| | The tree has L leaf nodes. | |
| | Each node n has a way to compute the total weight wₙ of the training examples associated with it. | |
| | Each non-leaf node n contains a split Xᵤ_{ₙ} ≦ vₙ with the left child corresponding to Xᵤ_{ₙ} ≦ vₙ, and the right | |
| | child corresponding to Xᵤ_{ₙ} > vₙ. | |
| | The value for variable Xᵥ has s + 1 value bins, (v₀, v₁] , . . . , (vₛ, vₛ₊₁], with v₀ < v₁ < . . . < vₛ < vₛ₊₁. | |
| 1: | function ComputeBinCoefficients(root: root node for the regression tree) | |
| 2: | A ← 0_{L×(s+1)} | |
| 3: | ComputeUnnormalizedBinCoefficients(root, 1ₛ₊₁) | |
| 4: | for t ε {0, . . . , s} do | [symbol] normalize columns of the coefficient matrix |

| 5: | A [:, t] ← A [:, t] /sum (A [:, t]) | |
|---|---|---|
| 6: | return A | [symbol] columns correspond to the coefficient values for each bin |

| | |
|---|---|
| 7: | procedure ComputeUnnormalizedBinCoefficients(n: node, η = (η₀, . . . , ηₛ): linear coefficients) |
| 8: | if n is a leaf then |
| 9: | A [n, :] ← η |
| 10: | else |
| 11: | l ← LeftChild (n) |
| 12: | r ← RightChild (n) |
| 13: | if SplitVariable (n) = Xᵥ then |
| 14: | ${η}_{l} ← ( {η}_{1}^{′} , … , {η}_{s + 1}^{′} ) s . t . {η}_{t}^{′} = \{ \begin{matrix}{η}_{t} & if SplitValue ( n ) \leq {v}_{t} , \\ 0 & if SplitValue ( n ) > {v}_{t} ,\end{matrix} t = 1 , … , s + 1.$ |
| 15: | ηᵣ ← η − ηₗ |
| 16: | ComputeUnnormalizedBinCoefficients (l, ηₗ) |
| 17: | ComputeUnnormalizedBinCoefficients (r, ηᵣ) |
| 18: | else |
| 19: | pₗ ← wₗ/ (wₗ + wᵣ), pᵣ ← wᵣ/ (wₗ + wᵣ) |
| 20: | ComputeUnnormalizedBinCoefficients (l, pₗη) |
| 21: | ComputeUnnormalizedBinCoefficients (r, pᵣη) |

The constraint generation module 270 determines the values of aₜ simultaneously for all t=0, . . . , s (as a matrix A with column t corresponding to aₜ) in the same tree. If the constraints are extended to span sums of multiple trees, the constraint generation module 270 determines the set of splits as the union of the splits for individual trees. The constraint generation module 270 constructs the parameters θ and coefficients a by concatenating the parameters and coefficients, respectively, over the set of added trees.

In some implementations, the constraint generation module 270 determines the set of constraints for a multivariate case with respect to a set of variables V={v₁, . . . , vₘ)}. The constraint generation module 270 identifies a m set of split points, −∞=v₀¹<v₁¹< . . . <vₛ₁¹<Vₛ₁₊₁¹=∞, . . . , −∞=v₀^{m}<v₁^{m}< . . . <vₛₘ^{m}<vₛₘ₊₁^{m}=∞. The constraint generation module 270 identifies value cells instead of value bins for the univariate case. The value cells is described

$${⊗}_{j = 1}^{m} ( {v}_{{t}_{j} - 1}^{, j} , {v}_{{t}_{j}}^{j} ]$$

for X_{V}, where

$$t = ( {t}_{1} , ⋯ , {t}_{m} ) ∈ {⊗}_{j = 1}^{m} \{ 1 , ⋯ , {s}_{j} , + 1 \} .$$

The constraint generation module 270 determines the constraint as

$$η ( t ) = {\hat{h}}_{\{ V \}} ( {x}_{V} ) for {x}_{V} ∈ {⊗}_{j = 1}^{m} ( {v}_{{t}_{j} - 1}^{, j} , {v}_{{t}_{j}}^{j} ] ,$$

the value cell with

$$t ∈ {⊗}_{j = 1}^{m} \{ 1 , ⋯ , {s}_{j} \} .$$

If t^{j}=(t₁, . . . , tⱼ₋₁, tⱼ+1, tⱼ₊₁, . . . , tₘ) if tⱼ<sⱼ and t^{j}=t tⱼ<sⱼ if tⱼ=sⱼ. The constraint generation module 270 determines the set of constraints associated with the monotonicity partial dependence function of X_{V} based on the below equation:

$${𝒞}_{V} = \{ \begin{matrix}\{ \begin{matrix}η ( t ) \leq η ( {t}^{j} ) \text{:} t ∈ {⊗}_{k = 1}^{m} \{ 1 , ⋯ , {s}_{k} \} and \\ j ∈ \{ 1 , ⋯ , m \}\end{matrix} \} & if non \text{-} decreasing ; \\ \{ \begin{matrix}η ( t ) \geq η ( {t}^{j} ) \text{:} t ∈ {⊗}_{k = 1}^{m} \{ 1 , ⋯ , {s}_{k} \} and \\ j ∈ \{ 1 , ⋯ , m \}\end{matrix} \} & if non \text{-} increasing .\end{matrix}$$

As shown in the above equation, the total number of constraints is therefore [symbol] (m×s₁× . . . ×sₘ). There can be computational challenges if m>3 or even m>2. Similar to the univariate case, the constraint generation module 270 determines the value of aₜ so that ηₜ=aₜ^{T}θ where θ are the parameters associated with the leaf nodes of the additive tree model. The algorithm in table 1 can be modified accordingly where line 13 is replaced with SplitVariable(n)∈X_{V} and line 14 is replaced with the multi-dimensional equivalent:

$${η}_{l} ← ( {η}_{1 ⋯ 1}^{′} , ⋯ , {η}_{{s}_{1} + 1 , ⋯ , {s}_{m} + 1}^{′} ) s . t . \\ {η}_{t}^{′} = \{ \begin{matrix}{η}_{t} & if SplitValue ( n ) \leq {v}_{{t}_{{o ( n )}^{′}}} \\ 0 & if SplitValue ( n ) > {v}_{{t}_{{o ( n )}^{′}}}\end{matrix} o ( n ) = SplitVariable ( n ) . \\ t ∈ {⊗}_{k = 1}^{m} \{ 1 , ⋯ , {s}_{k} \} .$$

The optimization module 280 includes computer logic executable by the processor 202 to receive a selection of an objective function and optimize the objective function subject to the set of the monotonicity constraints. In some implementations, the optimization module 280 receives the set of monotonicity constraints from the constraint generation module 270. In some implementations, the optimization module 280 receives an objective function selected by a user of the client device 114. For example, the objective function can be penalized local likelihood. The objective function is commonly convex for additive tree model.

The optimization module 280 determines whether the set of monotonicity constraints are linear. For example, if the set of monotonicity constraints are linear, then the optimization is a quadratic programming (QP) problem, which the optimization module 280 solves. The optimization problem to be solved by the optimization module 280 can be represented as

\hat{Θ}=arg min_{Θ}F(Θ|D,S)

There are many possible choices for selecting the loss function F(Θ|D,S) depending on the problem at hand. In some implementations, the optimization module 280 projects the existing solution \hat{Θ} on to the surface of the support set determined by the set of the monotonicity constraints. For example, F(Θ)=∥Θ−Θ∥₂. In some implementations, the optimization module 280 uses a regularized negative log-likelihood. For example, F(Θ|D,S)=−l(Θ)+R(Θ).

In some implementations, the optimization module 280 uses log-loss and mean squared errors as objectives. The optimization module 280 receives l₂ (ridge expression) regularization. For binary classification with labels Y∈{−1, 1},

$$F ( Θ \vert 𝒟 , S ) = {\sum }_{i = 1}^{N} ln \{ 1 + exp ( - {y}_{i} {\sum }_{k = 1}^{K} {T}_{k} ( {x}_{i} \vert {θ}_{k} , {S}_{k} ) ) \} + \frac{1}{2} λ {‖ Θ ‖}_{2}^{2}$$

where λ≧0 is the regularization parameter. For regression with labels Y∈ [symbol] ,

$${F ( Θ \vert 𝒟 , S ) = {\sum }_{i = 1}^{N} ( {y}_{i} - {\sum }_{k = 1}^{K} {T}_{k} ( {x}_{i} \vert {θ}_{k} , {S}_{k} ) )}^{2} + \frac{1}{2} λ {‖ Θ ‖}_{2}^{2}$$

In some implementations, the optimization module 280 interleaves the learning of the additive tree model with the re-estimation of the leaf parameters to impose the monotonicity. The optimization module 280 receives the splits S=(S₁, . . . , S_{K}) and re-estimates the parameters Θ=(θ₁, . . . , θ_{K}) so that the partial dependence function monotonicity is satisfied. In some implementations, the optimization module 280 sends instructions and the re-estimated set of parameters to the additive tree module 250 to retune the additive tree model and send the additive tree model to the prediction server 108 so that a generated prediction's partial dependence functions are monotonic in the selected sets of variables. In other words, the optimization module 280, by re-estimating the set of parameters for the additive tree model, approximates the prediction function ƒ subject to the monotonicity of the partial dependence functions in the selected sets of variables V=(V₁, . . . , V_{M}) and in the selected direction (≦ or ≧).

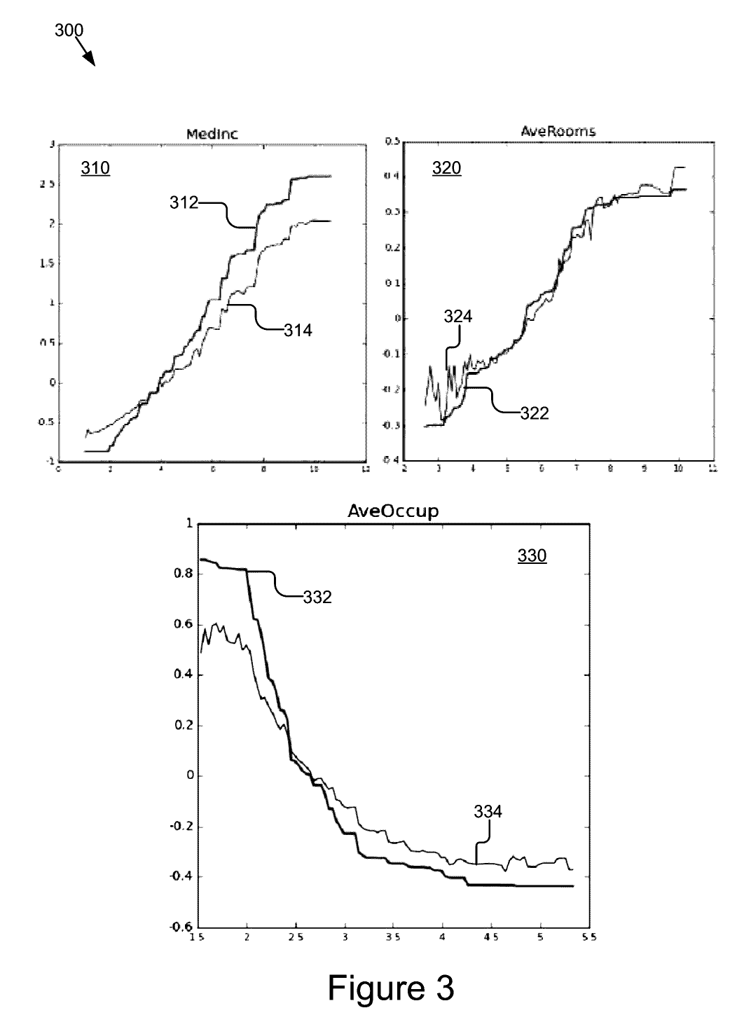

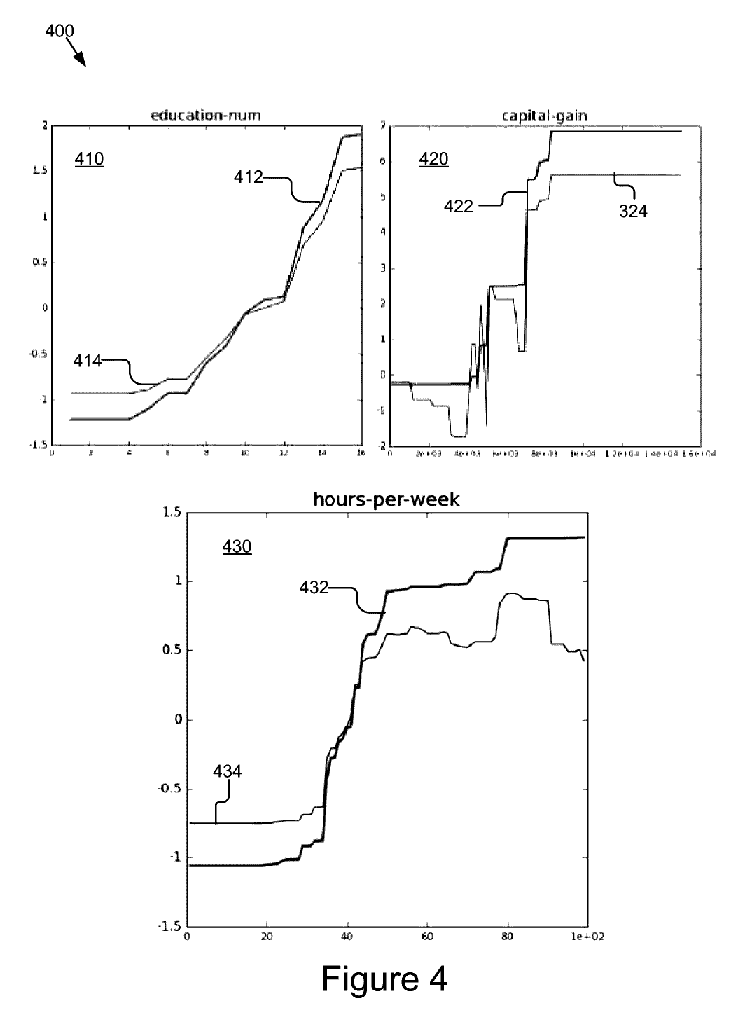

The user interface module 290 includes computer logic executable by the processor 202 for creating partial dependence plots illustrated in FIGS. 3-4 and providing optimized user interfaces, control buttons and other mechanisms. In some implementations, the user interface module 290 cooperates and coordinates with other components of the monotonicity constraints unit 104 to generate a user interface that allows the user to perform operations on experiments, features, models, data sets and projects in the same user interface. This is advantageous because it may allow the user to perform operations and modifications to multiple items at the same time. The user interface includes graphical elements that are interactive. The graphical elements can include, but are not limited to, radio buttons, selection buttons, checkboxes, tabs, drop down menus, scrollbars, tiles, text entry fields, icons, graphics, directed acyclic graph (DAG), plots, tables, etc.

FIG. 3 is a graphical representation of example partial dependence plots 310, 320 and 330 of constrained variables for a housing dataset in accordance with one implementation of the present disclosure. Partial dependence plot 310 is a partial dependence plot for the “MedInc” variable, which corresponds to median income. For the partial dependency plot 310, “MedInc” was selected as a constrained variable, i.e., a variable on which monotonicity is imposed). In this case, non-decreasing monotonicity (e.g. because domain knowledge may dictate that housing prices increase as the median income of the neighborhood increases). The illustrated partial dependency plot 310 includes a partial dependency plot for the “MedInc” variable for both the constrained additive tree model 312 generated by the monotonicity constraints unit 104 (which, as illustrated, is monotonic with respect to “MedInc”) and the initial, or unconstrained, additive tree model 314 (which, as illustrated, was not monotonic with respect to “MedInc”).

Partial dependence plot 320 is a partial dependence plot for the “AveRooms” variable, which corresponds to the average number of rooms. For the partial dependency plot 320, “AveRooms” was selected as a constrained variable with non-decreasing monotonicity (e.g. because domain knowledge may dictate that housing prices increase as the average number of rooms per house in the neighborhood increases). The illustrated partial dependency plot 320 includes a partial dependency plot for the “AveRooms” variable for both the constrained additive tree model 322 generated by the monotonicity constraints unit 104 (which, as illustrated, is monotonic with respect to “AveRooms”) and the initial, or unconstrained, additive tree model 324 (which, as illustrated, was not monotonic with respect to “AveRooms”).

Partial dependence plot 330 is a partial dependence plot for the “AveOccup” variable, which corresponds to average occupancy. For the partial dependency plot 320, AveOccup was selected as a constrained variable with non-increasing monotonicity (e.g. because domain knowledge may dictate that housing prices decrease as occupancy increases). The illustrated partial dependency plot 320 includes a partial dependency plot for the “AveOccup” variable for both the constrained additive tree model 322 generated by the monotonicity constraints unit 104 (which, as illustrated, is monotonic with respect to “AveOccup”) and the initial, or unconstrained, additive tree model 324 (which, as illustrated, was not monotonic with respect to “AveOccup”).

FIG. 4 is a graphical representation of example partial dependence plots 410, 420 and 430 of constrained variables for an income dataset in accordance with one implementation of the present disclosure. Partial dependence plot 410 is a partial dependence plot for the “education-num” variable, which corresponds to number of years of education. Partial dependence plot 420 is a partial dependence plot for the “capital-gain” variable, which corresponds to capital gains. Partial dependence plot 430 is a partial dependence plot for the “hours-per-week” variable, which corresponds to average occupancy. While the partial dependence plots 410, 420 and 430 of FIG. 4 are for a different data set and different additive tree model, similar to the partial dependency plots discussed above with reference to FIG. 3, the partial dependence plots 410, 420 and 430 illustrate that the monotonicity constraints unit 104 is imposing monotonicity on the partial dependence functions that may not have initially been monotonic.

While not shown, it should be recognized that partial dependence plots for multivariate monotonic partial dependence functions are within the scope of this disclosure and may be generated and provided for display. For example, assume that “MedInc” and “AveRooms” are selected as a multivariate monotonic partial dependence functions having non-decreasing monotonicity. In one implementation, the partial dependence plot is a contour plot with a contour for the multivariate of the constrained additive tree model having a maximum at the maximum “MedInc” and maximum “AveRooms” value, a minimum at the minimum “MedInc” and minimum “AveRooms” values and a non-negative slope at all points in the range between the minimum and maximum.

While not shown, it should be recognized that partial dependence plots for piecewise monotonic partial dependence functions are within the scope of this disclosure and may be generated and provided for display. For example, assume that “temperature” is selected as a variable for the partial dependence function having non-decreasing monotonicity for a first range (e.g. because bacterial growth increases with temperature between 40 degrees Fahrenheit and 101 degrees Fahrenheit) and has non-increasing temperature for a second range (e.g. because bacteria begin to die above 101 degrees Fahrenheit). In one implementation, the associated partial dependence plot include a partial dependency plot for the “temperature” variable for the constrained additive tree model 322 where the plot would be non-decreasing in the range (40,101) and non-increasing in the range (101, inf).

It should further be recognized that although the preceding bacteria example has a combined range that is continuous from 40 degrees Fahrenheit to infinity. Implementations with non-continuous ranges are contemplated and within the scope of this disclosure. For example, if bacteria begin to die off at 115 degrees Fahrenheit instead of 101, the second range would be (115, inf) and the partial dependence plot and constrained additive tree model would not necessarily have a partial dependence function monotonic with respect to “temperature” between 101 and 115 degrees Fahrenheit.

Presentation of partial dependence plots such as those of FIGS. 3 and 4 may beneficially provide a user with one or more of verification that monotonicity is being imposed and insight as to how the effects of imposing monotonicity on the partial dependence function (as shown by the difference between the constrained and unconstrained plots).

### Example Methods

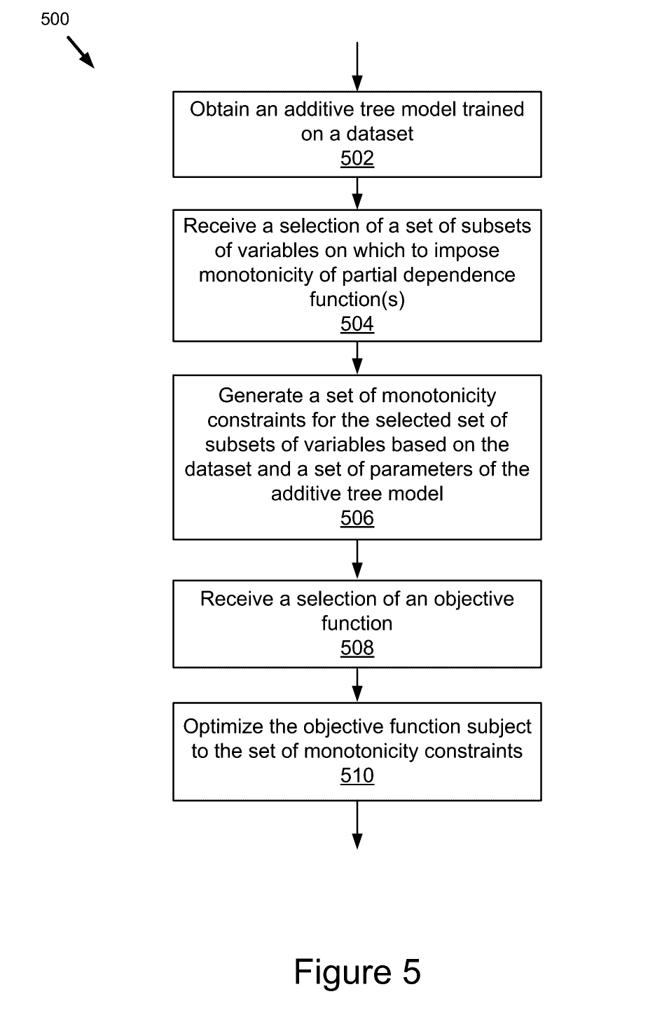

FIG. 5 is a flowchart of an example method 500 for generating monotonicity constraints in accordance with one implementation of the present disclosure. The method 500 begins at block 502. At block 502, the additive tree module 250 obtains an additive tree model trained on a dataset. At block 504, the monotonicity module 260 receives a selection of a set of subsets of variables on which to impose monotonicity of partial dependency function(s). At block 506, the constraint generation module 270 generates a set of monotonicity constraints for the partial dependence functions on the selected set of subsets of variables based on the dataset and a set of parameters of the additive tree model. At block 508, the optimization module 280 receives a selection of an objective function. At block 510, the optimization module 280 optimizes the objective function subject to the set of monotonicity constraints.

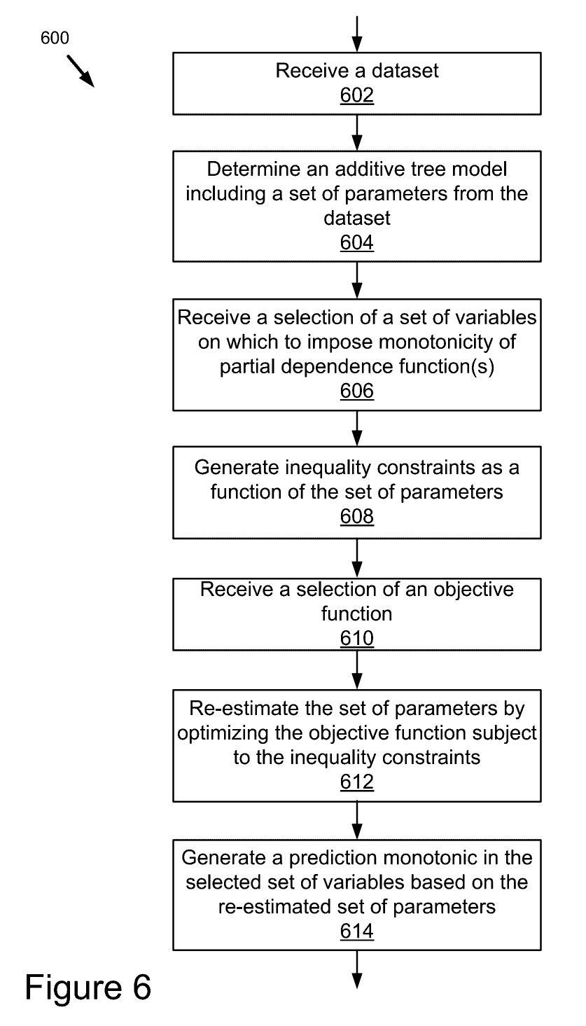

FIG. 6 is a flowchart of another example method 600 for generating monotonicity constraints in accordance with one implementation of the present disclosure. The method 600 begins at block 602. At block 602, the additive tree module 250 receives a dataset. At block 604, the additive tree module 250 determines an additive tree model including a set of parameters from the dataset. At block 606, the monotonicity module 260 receives a selection of a set of variables on which to impose monotonicity of partial dependence function(s). At block 608, the constraint generation module 270 generates inequality constraints as a function of the set of parameters. At block 610, the optimization module 280 receives a selection of an objective function. At block 612, the optimization module 280 re-estimates the set of parameters by optimizing the objective function subject to the inequality constraints. At block 614, the scoring unit 116 generates a prediction monotonic in the selected set of variables based on the re-estimated set of parameters.

The foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As should be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present disclosure may be implemented as software, hardware, firmware or any combination of the three. Also, wherever a component, an example of which is a module, of the present disclosure is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A computer-implemented method comprising:
receiving an additive tree model trained on a dataset;
receiving a selection of a set of subsets of variables on which to impose monotonicity of partial dependence functions;
generating a set of monotonicity constraints for the partial dependence functions in the selected set of subsets of variables based on the dataset and a set of parameters of the additive tree model;
receiving a selection of an objective function; and
optimizing the objective function subject to the set of monotonicity constraints.

2. The computer-implemented method of claim 1, wherein receiving the selection of the set of subsets of variables comprises:
receiving a first selection of a first subset of a first variable, the first subset of the first variable including a first range of the first variable and a first sign of monotonicity of the first variable for a first partial dependence function in the first variable;
receiving a second selection of a second subset of the first variable, the second subset of the first variable including a second range of the first variable and a second sign of monotonicity of the second variable for a second partial dependence function in the first variable; and
wherein the first subset of the first variable and the second subset of the second variable are included in the set of subsets of variables.

3. The computer-implemented method of claim 1, wherein receiving the selection of the set of subsets of variables comprises:
receiving a first selection of a first subset of a first variable and a second variable, the first subset of the first variable and the second variable including a first range of the first variable, a second range of the second variable, and a sign of monotonicity of the first variable and the second variable for a multivariate partial dependence function in the first variable and the second variable; and
wherein the first subset of the first variable and the second variable is included in the set of subsets of variables.

4. The computer-implemented method of claim 1, wherein optimizing the objective function subject to the set of monotonicity constraints comprises:
re-estimating the set of parameters, wherein the re-estimated set of parameters satisfy the set of monotonicity constraints.

5. The computer-implemented method of claim 4, further comprising:
generating a prediction using the additive tree model and the re-estimated set of parameters.

6. The computer-implemented method of claim 1, wherein the additive tree model is one from a group of gradient boosted trees, additive groves of regression trees and regularized greedy forest.

7. The computer-implemented method of claim 1, wherein the objective function is a penalized local likelihood.

8. The computer-implemented method of claim 1, wherein the set of monotonicity constraints are a function of the set of parameters of the additive tree model.

9. A system comprising:
one or more processors; and
a memory including instructions that, when executed by the one or more processors, cause the system to:
receive an additive tree model trained on a dataset;
receive a selection of a set of subsets of variables on which to impose monotonicity of partial dependence functions;
generate a set of monotonicity constraints for the partial dependence functions in the selected set of subsets of variables based on the dataset and a set of parameters of the additive tree model;
receive a selection of an objective function; and
optimize the objective function subject to the set of monotonicity constraints.

10. The system of claim 9, wherein the instructions to receive the selection of the set of subsets, when executed by the one or more processors, cause the system to:
receive a first selection of a first subset of a first variable, the first subset of the first variable including a first range of the first variable and a first sign of monotonicity of the first variable for a first partial dependence function in the first variable;
receive a second selection of a second subset of the first variable, the second subset of the first variable including a second range of the first variable and a second sign of monotonicity of the second variable for a second partial dependence function in the first variable; and
wherein the first subset of the first variable and the second subset of the second variable are included in the set of subsets of variables.

11. The system of claim 9, wherein the instructions to receive the selection of the set of subsets, when executed by the one or more processors, cause the system to:
receive a first selection of a first subset of a first variable and a second variable, the first subset of the first variable and the second variable including a first range of the first variable, a second range of the second variable, and a sign of monotonicity of the first variable and the second variable for a multivariate partial dependence function in the first variable and the second variable; and
wherein the first subset of the first variable and the second variable is included in the set of subsets of variables.

12. The system of claim 9, wherein the instructions to optimize the objective function subject to the set of monotonicity constraints, when executed by the one or more processors, cause the system to:
re-estimate the set of parameters, wherein the re-estimated set of parameters satisfy the set of monotonicity constraints.

13. The system of claim 12, wherein the instructions, when executed by the one or more processors, cause the system to:
generate a prediction using the additive tree model and the re-estimated set of parameters.

14. The system of claim 9, wherein the additive tree model is one from a group of gradient boosted trees, additive groves of regression trees and regularized greedy forest.

15. The system of claim 9, wherein the objective function is a penalized local likelihood.

16. The system of claim 9, wherein the set of monotonicity constraints are a function of the set of parameters of the additive tree model.

17. A computer-program product comprising a non-transitory computer usable medium including a computer readable program, wherein the computer readable program, when executed on a computer, causes the computer to perform operations comprising:
receiving an additive tree model trained on a dataset;
receiving a selection of a set of subsets of variables on which to impose monotonicity of partial dependence functions;
generating a set of monotonicity constraints for the partial dependence functions in the selected set of subsets of variables based on the dataset and a set of parameters of the additive tree model;
receiving a selection of an objective function; and
optimizing the objective function subject to the set of monotonicity constraints.

18. The computer program product of claim 17, wherein the operations for receiving the selection of the set of subsets of variables further comprise:
receiving a first selection of a first subset of a first variable, the first subset of the first variable including a first range of the first variable and a first sign of monotonicity of the first variable for a first partial dependence function in the first variable;
receiving a second selection of a second subset of the first variable, the second subset of the first variable including a second range of the first variable and a second sign of monotonicity of the second variable for a second partial dependence function in the first variable; and
wherein the first subset of the first variable and the second subset of the second variable are included in the set of subsets of variables.

19. The computer program product of claim 17, wherein the operations for receiving the selection of the set of subsets of variables further comprise:
receiving a first selection of a first subset of a first variable and a second variable, the first subset of the first variable and the second variable including a first range of the first variable, a second range of the second variable, and a sign of monotonicity of the first variable and the second variable for a multivariate partial dependence function in the first variable and the second variable; and
wherein the first subset of the first variable and the second variable is included in the set of subsets of variables.

20. The computer program product of claim 17, wherein the operations for optimizing the objective function subject to the set of monotonicity constraints further comprise:
re-estimating the set of parameters, wherein the re-estimated set of parameters satisfy the set of monotonicity constraints.
